(19) United States
(12) Patent Application Publication
(10) Pub. No.: US 2025/0055804 A1
(43) Pub. Date: Feb. 13, 2025

(54) COMMUNICATION APPARATUS, COMMUNICATION SYSTEM, AND COMMUNICATION METHOD

(71) Applicant: NEC Corporation, Minato-ku, Tokyo (JP)

(72) Inventors: Anan SAWABE, Tokyo (JP); Yusuke SHINOHARA, Tokyo (JP); Takanori IWAI, Tokyo (JP)

(73) Assignee: NEC Corporation, Minato-ku, Tokyo (JP)

(21) Appl. No.: 18/717,495

(22) PCT Filed: Dec. 22, 2021
(86) PCT No.: PCT/JP2021/047642

§ 371 Date: Jun. 7, 2024

(51) Int. Cl. H04L 47/283

(52) U.S. Cl. CPC H04L 47/283

(57) ABSTRACT

A communication apparatus (100) according to the present disclosure includes: a communication unit (101) configured to transmit a downlink packet via a network and receive an ACK packet for the downlink packet via the network; an acquisition unit (102) configured to acquire an RTT for the downlink packet already transmitted by the communication unit (101), the RTT being time from when the communication unit (101) transmits the downlink packet to when the communication unit (101) receives the ACK packet, and a transmission time of the downlink packet already transmitted by the communication unit (101); and a transmission timing control unit (103) configured to control transmission timing of the downlink packet by the communication unit (101) on the basis of the RTT of the downlink packet already transmitted by the communication unit (101) and a transmission time of the downlink packet already transmitted by the communication unit (101).

### TECHNICAL FIELD

The present disclosure relates to a communication apparatus, a communication system, and a communication method.

### BACKGROUND ART

In a transmission control protocol (TCP), network congestion control is performed by a scheme called congestion window control (for example, Patent Literature 1).

In the congestion window control scheme, a transmission-side communication apparatus changes the size of the congestion window in correspondence with a congestion state of the network, and limits the amount of data (TCP segment) flowing in the network in accordance with the size of the congestion window.

Specifically, the transmission-side communication apparatus determines a congestion state of a network in accordance with the magnitude of a round trip time (RTT) that is time from when data flows to the network until an acknowledge (ACK) packet for the data is returned from the other party. When the RTT is small, the transmission-side communication apparatus determines that the network is not congested, and increases a size of a congestion window. On the other hand, when the RTT is large, the transmission-side communication apparatus determines that the network is congested, and reduces the size of the congestion window.

As a result, the transmission-side communication apparatus can flow a large amount of data to the network while avoiding network congestion.

### CITATION LIST

### Patent Literature

Patent Literature 1: Japanese Unexamined Patent Application Publication No. 2016-040857

### SUMMARY OF INVENTION

### Technical Problem

However, the present inventors have found a problem that in the congestion window control scheme, for example, in a case where the reception-side communication apparatus uses a time division duplex (TDD) scheme, when growth of the congestion window is stopped (the size does not increase), a dead time for which data is not transmitted although data can be transmitted occurs in the transmission-side communication apparatus.

Therefore, in consideration of the above-described problems, an object of the present disclosure is to provide a communication apparatus, a communication system, and a communication method capable of reducing dead time in a transmission-side communication apparatus.

### Solution to Problem

A communication apparatus according to an aspect includes:
a communication unit configured to transmit a downlink packet via a network and receive an acknowledge (ACK) packet for the downlink packet via the network;
an acquisition unit configured to acquire a round trip time (RTT) for the downlink packet already transmitted by the communication unit, the RTT being time from when the communication unit transmits the downlink packet to when the communication unit receives the ACK packet, and a transmission time of the downlink packet already transmitted by the communication unit; and
a transmission timing control unit configured to control transmission timing of the downlink packet by the communication unit on the basis of the RTT of the downlink packet already transmitted by the communication unit and a transmission time of the downlink packet already transmitted by the communication unit.

A communication system according to another aspect includes:
a communication unit configured to transmit a downlink packet to a reception-side communication apparatus via a network and receive an acknowledge (ACK) packet for the downlink packet from the reception-side communication apparatus via the network;
an acquisition unit configured to acquire a round trip time (RTT) for the downlink packet already transmitted by the communication unit, the RTT being time from when the communication unit transmits the downlink packet to when the communication unit receives the ACK packet, and a transmission time of the downlink packet already transmitted by the communication unit; and
a transmission timing control unit configured to control transmission timing of the downlink packet by the communication unit on the basis of the RTT of the downlink packet already transmitted by the communication unit and a transmission time of the downlink packet already transmitted by the communication unit.

A communication method according to still another aspect is
a communication method by a communication apparatus, the method including:
a communication step of transmitting a downlink packet via a network and receiving an acknowledge (ACK) packet for the downlink packet via the network;
an acquisition step of acquiring a round trip time (RTT) for the downlink packet already transmitted in the communication step, the RTT being time from when the downlink packet is transmitted in the communication step to when the ACK packet is received in the transmission step, and a transmission time of the downlink packet already transmitted in the communication step; and
a transmission timing control step of controlling transmission timing of the downlink packet in the communication step on the basis of the RTT of the downlink packet already transmitted in the communication step and a transmission time of the downlink packet already transmitted in the communication step.

### Advantageous Effects of Invention

According to the above-described aspects, it is possible to provide a communication apparatus, a communication system, and a communication method capable of reducing dead time in a transmission-side communication apparatus.

### BRIEF DESCRIPTION OF DRAWINGS

FIG. 1 is a view for explaining a problem in a congestion window control scheme.

FIG. 2 is a view illustrating a configuration example of a communication system according to a first example embodiment.

FIG. 3 is a flowchart illustrating an example of a schematic operation flow of the transmission-side communication apparatus according to the first example embodiment.

FIG. 4 is a view illustrating a configuration example of a communication system according to a second example embodiment.

FIG. 5 is a view illustrating an example of a schematic operation of a transmission timing control unit according to the second example embodiment.

FIG. 6 is a view illustrating an example of an RTT acquired by an acquisition unit according to the second example embodiment.

FIG. 7 is a view illustrating an example of a transmission time of a downlink packet with a small RTT.

FIG. 8 is a flowchart illustrating an example of a schematic operation flow of a server according to the second example embodiment.

FIG. 9 is a block diagram illustrating a hardware configuration example of a computer that implements the transmission-side communication apparatus according to the first example embodiment and the server according to the second example embodiment.

### EXAMPLE EMBODIMENT

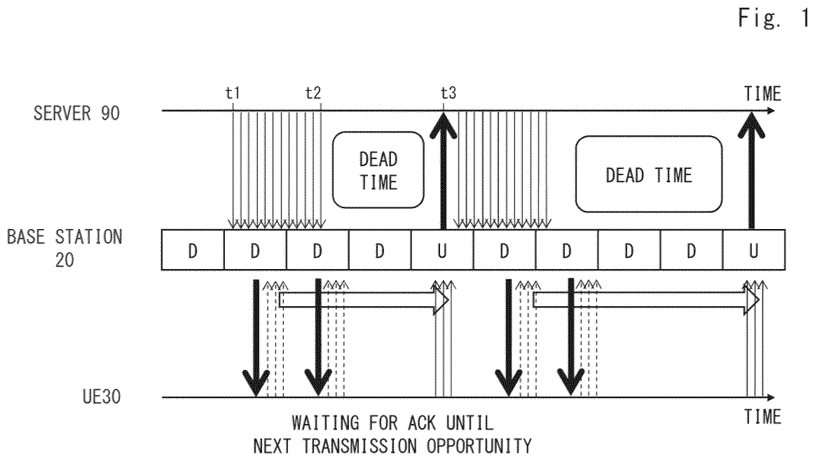

Before describing the present example embodiment, problems in a congestion window control scheme discovered by the present inventors will be described with reference to FIG. 1.

In the example of FIG. 1, a server 90 transmits a downlink packet to a user equipment (UE) 30 via a base station 20. That is, the server 90 serves as a transmission-side communication apparatus, and the base station 20 serves as a reception-side communication apparatus. In addition, a TDD scheme is used for communication between the base station 20 and the UE 30. In addition, “D” in the drawing indicates a downlink slot which is a time slot allocated to a downlink from the base station 20 to the UE 30, and “U” in the drawing indicates an uplink slot which is a time slot allocated to an uplink from the UE 30 to the base station 20.

At time t1, the server 90 transmits a downlink packet of a data amount corresponding to the size of a congestion window at that point of time to the base station 20. Since the downlink slot is allocated when the downlink packet is received from the server 90, the base station 20 transmits the downlink packet, received from the server 90, to the UE 30.

When receiving the downlink packet, the UE 30 transmits an ACK packet for the downlink packet. However, the downlink slot is allocated when the downlink packet is received from the base station 20. Therefore, the UE 30 is kept waiting for transmission of the ACK packet until the transmission opportunity at time t3 at which the uplink slot is allocated. Then, at time t3, the UE 30 transmits an ACK packet to the base station 20, and the base station 20 transmits the ACK packet to the server 90.

When receiving the ACK packet from the base station 20, the server 90 resumes the transmission of the downlink packet. As described above, in the server 90, in order to transmit the next downlink packet, it is necessary to wait until the ACK packet is received. As a result, in the server 90, time from time t2 when transmission of the downlink packet is completed to time t3 when the ACK packet is received is a dead time during which the downlink packet is not transmitted although the downlink packet can be transmitted.

In addition, in the server 90, since an RTT, from transmission of the downlink packet to reception of the ACK packet, increases, it is determined that the network is congested, and growth of the congestion window stops (the size does not increase). Therefore, at the time of transmitting the next downlink packet, the server 90 can transmit only a downlink packet of a data amount corresponding to the size of the congestion window in the stopped growth state. As a result, in the server 90, a dead time occurs even after the next downlink packet is transmitted.

Example embodiments of the present disclosure will be described below with reference to the drawings. Note that, in the description and drawings to be described below, omission and simplification are made as appropriate for clarity of description. Furthermore, in each of the drawings described below, the same element is denoted by the same reference numeral, and redundant description will be omitted as necessary. In addition, specific numerical values and the like shown below are only examples to facilitate understanding of the present disclosure, and are not limited thereto.

### First Example Embodiment

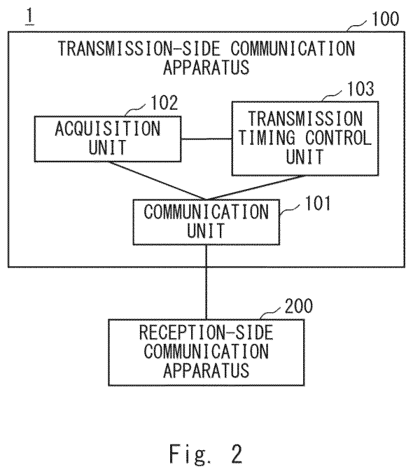

First, a configuration example of a communication system 1 according to a first example embodiment will be described with reference to FIG. 2.

As illustrated in FIG. 2, the communication system 1 according to the first example embodiment includes a transmission-side communication apparatus 100 and a reception-side communication apparatus 200. Furthermore, the transmission-side communication apparatus 100 includes a communication unit 101, an acquisition unit 102, and a transmission timing control unit 103. Note that, the transmission-side communication apparatus 100 is, for example, a server such as a web server, and the reception-side communication apparatus 200 is, for example, a base station.

The communication unit 101 transmits a downlink packet to the reception-side communication apparatus 200 via a network, and receives an ACK packet for the downlink packet from the reception-side communication apparatus 200 via the network.

Note that, the network according to the first example embodiment usually refers to a communication network (whether wired or wireless) between the transmission-side communication apparatus 100 and the reception-side communication apparatus 200. However, in a case where the reception-side communication apparatus 200 is a base station, the network refers to a communication network including a communication network between the transmission-side communication apparatus 100 and the reception-side communication apparatus 200 and a wireless communication network between the reception-side communication apparatus 200 and terminals such as UEs.

The acquisition unit 102 acquires an RTT for a downlink packet already transmitted by the communication unit 101 and a transmission time of the downlink packet already transmitted by the communication unit 101. The RTT for the downlink packet already transmitted by the communication unit 101 is time from when the communication unit 101 transmits the downlink packet to when the communication unit 101 receives an ACK packet for the downlink packet. For example, it is conceivable that the acquisition unit 102 acquires the RTT using ping. However, the method of obtaining the RTT is not limited thereto. Furthermore, for example, the acquisition unit 102 may manage the transmission time of the downlink packet by itself or may acquire the transmission time from the communication unit 101.

The transmission timing control unit 103 controls transmission timing of the downlink packet by the communication unit 101 on the basis of the RTT for the downlink packet already transmitted by the communication unit 101 and the transmission time of the downlink packet already transmitted by the communication unit 101. The transmission timing controlled by the transmission timing control unit 103 is transmission timing of the downlink packet that the communication unit 101 will subsequently transmit.

In response to this, the communication unit 101 transmits the downlink packet at the transmission timing controlled by the transmission timing control unit 103.

Note that, the reception-side communication apparatus 200 may be implemented by any communication apparatus as long as the communication apparatus has a function of receiving a downlink packet from the transmission-side communication apparatus 100 and transmitting an ACK packet for the downlink packet to the transmission-side communication apparatus 100, or a function of receiving a downlink packet from the transmission-side communication apparatus 100, transferring the downlink packet to another apparatus (when the reception-side communication apparatus 200 is a base station, another apparatus is a terminal such as UE), receiving an ACK packet for the downlink packet from another apparatus, and transmitting the ACK packet to the transmission-side communication apparatus 100. Therefore, a detailed configuration of the reception-side communication apparatus 200 will not be described.

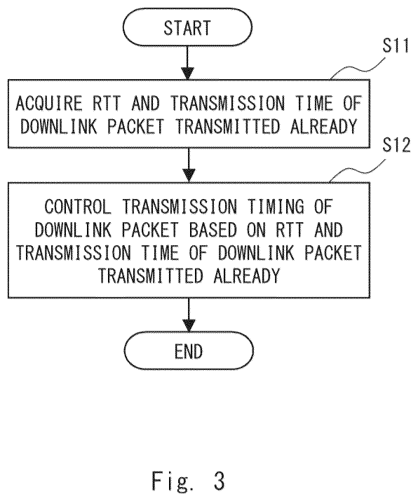

Next, an example of a schematic operation flow of the transmission-side communication apparatus 100 according to the first example embodiment will be described with reference to FIG. 3.

As illustrated in FIG. 3, first, the acquisition unit 102 acquires an RTT for a downlink packet already transmitted by the communication unit 101 and a transmission time of the downlink packet already transmitted by the communication unit 101 (step S11).

Then, the transmission timing control unit 103 controls transmission timing of the downlink packet by the communication unit 101 on the basis of the RTT for the downlink packet already transmitted by the communication unit 101 and the transmission time of the downlink packet already transmitted by the communication unit 101 (step S12).

According to the first example embodiment described above, the transmission-side communication apparatus 100 controls transmission timing of the downlink packet by the communication unit 101 on the basis of the RTT for the downlink packet already transmitted by the communication unit 101 and the transmission time of the downlink packet already transmitted by the communication unit 101. As a result, since the RTT can be reduced, the transmission-side communication apparatus 100 can grow a congestion window (increase the size). As a result, in the transmission-side communication apparatus 100, the amount of data of the downlink packet flowing through the network increases, and thus, it is possible to reduce dead time.

The transmission timing control unit 103 may specify the transmission timing of the downlink packet with the minimum RTT among the downlink packets already transmitted by the communication unit 101, and control the transmission timing of the downlink packet by the communication unit 101 on the basis of the specified transmission time and a scheduling interval of the network. For example, when the reception-side communication apparatus 200 is a base station that communicates with a terminal by a TDD scheme, the scheduling interval of the network may be an uplink slot interval allocated to the uplink. Note that, the scheduling interval of the network may be calculated by any constituent element in the transmission-side communication apparatus 100 or may be acquired from an external device.

In addition, the transmission-side communication apparatus 100 may control the transmission timing of the downlink packet by the communication unit 101 so that the downlink packet is transmitted when time corresponding to the scheduling interval of the network has elapsed from the specified transmission time. Note that, the transmission timing may have a time width such as a time width determined within a predetermined time range before and after timing at which time corresponding to the scheduling interval has elapsed.

The transmission-side communication apparatus 100 may further include a transmission rate control unit that acquires a state of the network and controls a transmission bit rate of the downlink packet transmitted by the communication unit 101 on the basis of the acquired state of the network. In this case, the communication unit 101 may transmit the downlink packet at the transmission bit rate controlled by the transmission rate control unit. In addition, the transmission rate control unit may acquire an increase/decrease status of the RTT in the network as the state of the network.

In addition, the transmission timing control unit 103 may specify the transmission timing of the downlink packet with the minimum RTT among the downlink packets already transmitted by the communication unit 101, and control the transmission timing of the downlink packet by the communication unit 101 on the basis of the specified transmission time, the scheduling interval of the network, and the transmission bit rate of the downlink packet by the communication unit 101.

### Second Example Embodiment

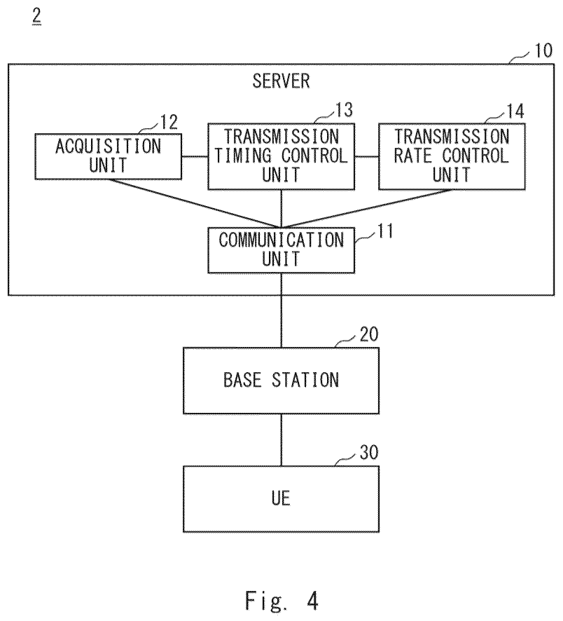

Next, a configuration example of a communication system 2 according to the second example embodiment will be described with reference to FIG. 4. The second example embodiment corresponds to an example embodiment in which the above-described first example embodiment is further embodied.

As illustrated in FIG. 4, the communication system 2 according to the second example embodiment includes a server 10, a base station 20, and a UE 30. Note that, a TDD scheme is used for communication between the base station 20 and the UE 30. Furthermore, the server 10 includes a communication unit 11, an acquisition unit 12, a transmission timing control unit 13, and a transmission rate control unit 14. Note that, the server 10 is an example of a transmission-side communication apparatus, and is, for example, a web server or the like. In addition, the base station 20 is an example of a reception-side communication apparatus.

The communication unit 11 transmits a downlink packet to the UE 30 via the base station 20, and receives an ACK packet for the downlink packet from the UE 30 via the base station 20.

Note that, the network according to the present second example embodiment refers to a communication network including a communication network (whether wired or wireless) between the server 10 and the base station 20 and a wireless communication network between the base station 20 and the UE 30. Note that, the radio communication network between the base station 20 and the UE 30 may be long term evolution (LTE), 4G (generation), 5G, local 5G, or the like.

The acquisition unit 12 acquires an RTT for a downlink packet already transmitted by the communication unit 11 and a transmission time of the downlink packet already transmitted by the communication unit 11. The RTT for the downlink packet already transmitted by the communication unit 11 is time from when the communication unit 11 transmits the downlink packet to when the communication unit 11 receives an ACK packet for the downlink packet. For example, it is conceivable that the acquisition unit 12 acquires the RTT using ping. However, the method of obtaining the RTT is not limited thereto. Furthermore, for example, the acquisition unit 12 may manage the transmission time of the downlink packet by itself or may acquire the transmission time from the communication unit 11.

The transmission timing control unit 13 controls transmission timing of the downlink packet by the communication unit 11 on the basis of the RTT for the downlink packet already transmitted by the communication unit 11 and the transmission time of the downlink packet already transmitted by the communication unit 11. The transmission timing controlled by the transmission timing control unit 13 is transmission timing of the downlink packet that the communication unit 11 will subsequently transmit.

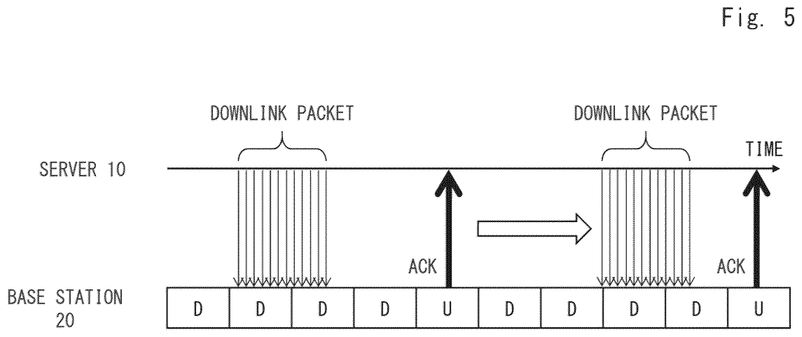

For example, as illustrated in FIG. 5, the transmission timing control unit 13 makes the transmission timing of the downlink packet close to the uplink slot in which the base station 20 transmits the ACK packet to the server 10 in consideration of the reception timing of the ACK packet. As a result, since the RTT can be reduced, the congestion window can be grown (the size can be increased).

The transmission rate control unit 14 acquires a state of the network and controls a transmission bit rate of the downlink packet by the communication unit 11 on the basis of the acquired state of the network. For example, the transmission rate control unit 14 acquires an increase/decrease status of the RTT in the network as the state of the network.

In response to this, the communication unit 11 transmits the downlink packet at transmission timing controlled by the transmission timing control unit 13 and at a transmission bit rate controlled by the transmission rate control unit 14.

Next, operations of the transmission timing control unit 13 and the transmission rate control unit 14 will be described in detail.

First, the operation of the transmission timing control unit 13 will be described in detail.

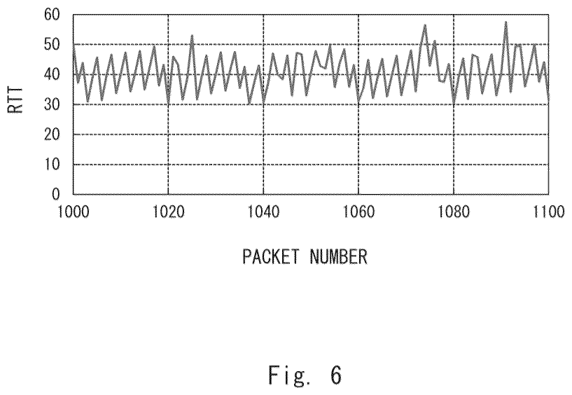

FIG. 6 illustrates an example of the RTT acquired by the acquisition unit 12. In FIG. 6, the vertical axis represents an RTT, and the horizontal axis represents a packet number of the downlink packet. Here, the communication unit 11 increments the packet number whenever transmitting a downlink packet. Therefore, the downlink packet with the largest packet number is the most recently transmitted downlink packet.

In the example of FIG. 6, the RTT has a sawtooth shape. This is because the UE 30 collectively transmits a plurality of ACK packets, for a plurality of downlink packets transmitted by the base station 20 in a plurality of downlink slots, in one uplink slot.

Therefore, there are downlink packets with a small RTT and downlink packets with a large RTT. Among these, the transmission time of the downlink packet with a small RTT is considered to be close to the uplink slot in which the base station 20 transmits the ACK packet to the server 10.

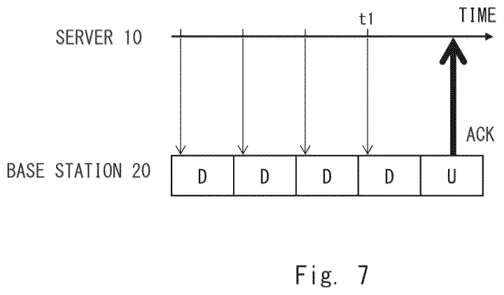

For example, in the example of FIG. 7, time t1 close to the uplink slot is considered to be the transmission time of the downlink packet with a small RTT. Therefore, when the downlink packet is transmitted based on the time t1, it is considered that the state in which the RTT is small is maintained.

Therefore, the transmission timing control unit 13 controls transmission timing of the downlink packet so as to transmit the downlink packet when time corresponding to an interval of the uplink slot has elapsed from the transmission time of the downlink packet with a small RTT.

Specifically, the transmission timing control unit 13 sets the transmission time of the downlink packet with the minimum RTT as S_{base}, and sets a scheduling interval of the network, that is, an uplink slot interval as δ.

Then, the transmission timing control unit 13 sets the transmission timing of the downlink packet as in the following Mathematical Expression 1.

$$Transmission timing = {S}_{base} + n δ - offset \qquad [ Mathematical Expression 1 ]$$

Here, n is 1, 2, 3, . . . .

In addition, offset is a coefficient that increases as the transmission bit rate increases. Provided that, the offset is a coefficient satisfying a relationship of 0≤offset<δ.

Next, the operation of the transmission rate control unit 14 will be described in detail.

The transmission rate control unit 14 acquires an increase/decrease status of the RTT in the network as the state of the network. Here, it is assumed that the increase/decrease status of the RTT indicates any of increase, stable, and decrease.

For example, when the RTT is increasing, the transmission rate control unit 14 decreases the transmission bit rate Rate (t) [bps] of the downlink packet. For example, the transmission rate control unit 14 sets Rate (t) as in the following Mathematical Expression 2.

$$Rate ( t ) = α \times Rate ( t - 1 ) \qquad [ Mathematical Expression 2 ]$$

Here, α is a coefficient satisfying a relationship of 0<α<1.

On the other hand, when the RTT is stable or decreasing, the transmission rate control unit 14 increases the transmission bit rate Rate (t) [bps] of the downlink packet. For example, the transmission rate control unit 14 sets Rate (t) as in the following Mathematical Expression 3.

$$Rate ( t ) = Rate ( t - 1 ) + β \times Rate ( t - 1 ) \qquad [ Mathematical Expression 3 ]$$

Here, β is a coefficient satisfying a relationship of 0<β<1.

Note that, the base station 20 may be implemented by any base station as long as the base station has a function of communicating with the UE 30 by the TDD scheme, and a function of receiving a downlink packet from the server 10, transferring the downlink packet to the UE 30, receiving an ACK packet for the downlink packet from the UE 30, and transmitting the ACK packet to the server 10. In addition, the UE 30 may be realized by any terminal as long as the terminal has a function of communicating with the base station 20 by the TDD scheme and a function of receiving a downlink packet from the base station 20 and transmitting an ACK packet for the downlink packet to the base station 20. Therefore, detailed configurations of the base station 20 and the UE 30 will not be described.

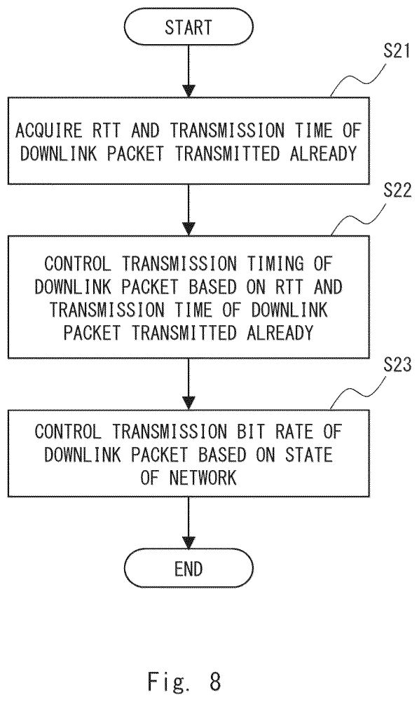

Next, an example of a schematic operation flow of the server 10 according to the second example embodiment will be described with reference to FIG. 8.

As illustrated in FIG. 8, first, the acquisition unit 12 acquires an RTT for a downlink packet already transmitted by the communication unit 11 and a transmission time of the downlink packet already transmitted by the communication unit 11 (step S21).

Next, the transmission timing control unit 13 controls transmission timing of the downlink packet by the communication unit 11 on the basis of the RTT for the downlink packet already transmitted by the communication unit 11 and the transmission time of the downlink packet already transmitted by the communication unit 11 (step S22).

Then, the transmission rate control unit 14 acquires a state of the network and controls a transmission bit rate of the downlink packet transmitted by the communication unit 101 on the basis of the acquired state of the network (step S23).

Note that, the order of steps S22 and S23 is not limited thereto. For example, step S23 may be executed first, and then step S22 may be executed, or steps S22 and S23 may be executed substantially simultaneously and in parallel.

According to the second example embodiment described above, the server 10 controls transmission timing of the downlink packet by the communication unit 11 on the basis of the RTT for the downlink packet already transmitted by the communication unit 11 and the transmission time of the downlink packet already transmitted by the communication unit 11. As a result, since the RTT can be reduced, the server 10 can grow the congestion window (can increase the size). As a result, in the server 10, the amount of data of the downlink packet flowing through the network increases, and thus, it is possible to reduce dead time.

In addition, the server 10 can increase the data amount of the downlink packet flowing to the network by growing the congestion window, but when the data amount exceeds an allowable amount that can be transmitted in the downlink slot existing between the two uplink slots, a queuing delay occurs. Then, the server 10 acquires a state of the network and controls a transmission bit rate of the downlink packet by the communication unit 11 on the basis of the state of the network. As a result, in correspondence with the state of the network, it is possible to control the amount of data of the downlink packet flowing to the network so that the queuing delay does not occur. As a result, in the server 10, a throughput can be improved.

### <Hardware Configuration of Transmission-Side Communication Apparatus and Server According to Example Embodiment>

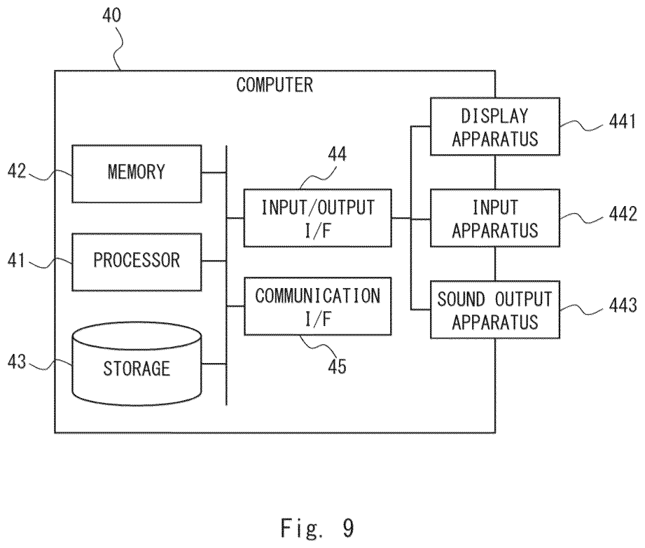

Next, a hardware configuration example of a computer 40 that implements the transmission-side communication apparatus 100 according to the first example embodiment described above and the server 10 according to the second example embodiment described above will be described with reference to FIG. 9.

As illustrated in FIG. 9, the computer 40 includes a processor 41, a memory 42, a storage 43, an input/output interface (input/output I/F) 44, a communication interface (communication I/F) 45, and the like. The processor 41, the memory 42, the storage 43, the input/output interface 44, and the communication interface 45 are connected by a data transmission path for mutually transmitting and receiving data.

The processor 41 is, for example, an arithmetic processing apparatus such as a central processing unit (CPU) and a graphics processing unit (GPU). The memory 42 is, for example, a memory such as a random access memory (RAM) and a read only memory (ROM). The storage 43 is, for example, a storage device such as a hard disk drive (HDD), a solid state drive (SSD), and a memory card. Furthermore, the storage 43 may be a memory such as a RAM and a ROM.

The storage 43 stores a program for realizing functions of constituent elements included in the transmission-side communication apparatus 100 or the server 10. The processor 41 implements the functions of the constituent elements included in the transmission-side communication apparatus 100 or the server 10 by executing the programs. Here, in execution of each of the programs described above, the processor 41 may load the programs into the memory 42, and may execute the programs, or may execute the programs without loading the programs into the memory 42. In addition, the memory 42 and the storage 43 also play a role of implementing a storage function included in the transmission-side communication apparatus 100 or the server 10.

In addition, the above-described program includes a command group (or software code) for causing a computer to perform one or more functions in the transmission-side communication apparatus 100 or the server 10 described in the example embodiments when being read by the computer. The program may be stored in a non-transitory computer-readable medium or a tangible storage medium. As an example and not by way of limitation, the computer readable medium or the tangible storage medium includes a RAM, a ROM, a flash memory, an SSD or other memory technologies, a compact disc (CD)-ROM, a digital versatile disc (DVD), a Blu-ray (registered trademark) disk or other optical disk storages, a magnetic cassette, a magnetic tape, a magnetic disk storage, or other magnetic storage apparatuses. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 44 is connected to a display apparatus 441, an input apparatus 442, a sound output apparatus 443, and the like. The display apparatus 441 is an apparatus that displays a screen corresponding to drawing data processed by the processor 41 such as a liquid crystal display (LCD), a cathode ray tube (CRT) display, and a monitor. The input apparatus 442 is an apparatus that receives an operation input of an operator, and is, for example, a keyboard, a mouse, a touch sensor, or the like. The display apparatus 441 and the input apparatus 442 may be integrated and implemented as a touch panel. The sound output apparatus 443 is an apparatus that acoustically outputs a sound corresponding to audio data processed by the processor 41 such as a speaker.

The communication interface 45 transmits and receives data to and from an external apparatus. For example, the communication interface 45 performs communication with the external apparatus via a wired communication line or a wireless communication line.

The present disclosure has been described above with reference to the example embodiments, but the present disclosure is not limited to the example embodiments described above. Various modifications that can be understood by those skilled in the art can be made to the configuration and details of the present disclosure within the scope of the present disclosure.

In addition, some or all of the above-described example embodiments may be described in supplementary notes below, but are not limited thereto.

### Supplementary Note 1

A communication apparatus including:
a communication unit configured to transmit a downlink packet via a network and receive an acknowledge (ACK) packet for the downlink packet via the network;
an acquisition unit configured to acquire a round trip time (RTT) for the downlink packet already transmitted by the communication unit, the RTT being time from when the communication unit transmits the downlink packet to when the communication unit receives the ACK packet, and a transmission time of the downlink packet already transmitted by the communication unit; and
a transmission timing control unit configured to control transmission timing of the downlink packet by the communication unit on the basis of the RTT of the downlink packet already transmitted by the communication unit and a transmission time of the downlink packet already transmitted by the communication unit.

### Supplementary Note 2

The communication apparatus according to Supplementary Note 1, wherein the transmission timing control unit,
specifies a transmission time of a downlink packet with a minimum RTT among downlink packets already transmitted by the communication unit, and
controls transmission timing of the downlink packet by the communication unit on the basis of the specified transmission time and a scheduling interval of the network.

### Supplementary Note 3

The communication apparatus according to Supplementary Note 2, wherein the transmission timing control unit controls transmission timing of the downlink packet by the communication unit so that the downlink packet is transmitted when time corresponding to the scheduling interval of the network has elapsed from the specified transmission time.

### Supplementary Note 4

The communication apparatus according to Supplementary Note 3, further including a transmission rate control unit configured to acquire a state of the network and control a transmission bit rate of the downlink packet by the communication unit on the basis of the acquired state of the network.

### Supplementary Note 5

The communication apparatus according to Supplementary Note 4, wherein the transmission rate control unit acquires an increase/decrease status of the RTT in the network as a state of the network.

### Supplementary Note 6

The communication apparatus according to Supplementary Note 4 or 5, wherein the transmission timing control unit controls transmission timing of the downlink packet by the communication unit on the basis of the specified transmission time, the scheduling interval of the network, and the transmission bit rate of the downlink packet by the communication unit.

### Supplementary Note 7

A communication system including:
a communication unit configured to transmit a downlink packet to a reception-side communication apparatus via a network and receive an acknowledge (ACK) packet for the downlink packet from the reception-side communication apparatus via the network;
an acquisition unit configured to acquire a round trip time (RTT) for the downlink packet already transmitted by the communication unit, the RTT being time from when the communication unit transmits the downlink packet to when the communication unit receives the ACK packet, and a transmission time of the downlink packet already transmitted by the communication unit; and
a transmission timing control unit configured to control transmission timing of the downlink packet by the communication unit on the basis of the RTT of the downlink packet already transmitted by the communication unit and a transmission time of the downlink packet already transmitted by the communication unit.

### Supplementary Note 8

The communication system according to Supplementary Note 7, wherein the transmission timing control unit,
specifies a transmission time of a downlink packet with a minimum RTT among downlink packets already transmitted by the communication unit, and
controls transmission timing of the downlink packet by the communication unit on the basis of the specified transmission time and a scheduling interval of the network.

### Supplementary Note 9

The communication system according to Supplementary Note 8, wherein the transmission timing control unit controls transmission timing of the downlink packet by the communication unit so that the downlink packet is transmitted when time corresponding to the scheduling interval of the network has elapsed from the specified transmission time.

### Supplementary Note 10

The communication system according to Supplementary Note 9, further including a transmission rate control unit configured to acquire a state of the network and control a transmission bit rate of the downlink packet by the communication unit on the basis of the acquired state of the network.

### Supplementary Note 11

The communication system according to Supplementary Note 10, wherein the transmission rate control unit acquires an increase/decrease status of the RTT in the network as a state of the network.

### Supplementary Note 12

The communication system according to Supplementary Note 10 or 11, wherein the transmission timing control unit controls transmission timing of the downlink packet by the communication unit on the basis of the specified transmission time, the scheduling interval of the network, and the transmission bit rate of the downlink packet by the communication unit.

### Supplementary Note 13

A communication method by a communication apparatus, the method including:
a communication step of transmitting a downlink packet via a network and receiving an acknowledge (ACK) packet for the downlink packet via the network;
an acquisition step of acquiring a round trip time (RTT) for the downlink packet already transmitted in the communication step, the RTT being time from when the downlink packet is transmitted in the communication step to when the ACK packet is received in the transmission step, and a transmission time of the downlink packet already transmitted in the communication step; and
a transmission timing control step of controlling transmission timing of the downlink packet in the communication step on the basis of the RTT of the downlink packet already transmitted in the communication step and a transmission time of the downlink packet already transmitted in the communication step.

### Supplementary Note 14

The communication method according to Supplementary Note 13, wherein, in the transmission timing control step,
a transmission time of a downlink packet with a minimum RTT among downlink packets already transmitted in the communication step is specified, and
transmission timing of the downlink packet in the communication step is controlled on the basis of the specified transmission time and a scheduling interval of the network.

### Supplementary Note 15

The communication method according to Supplementary Note 14, wherein, in the transmission timing control step, transmission timing of the downlink packet in the communication step is controlled so that the downlink packet is transmitted when time corresponding to the scheduling interval of the network has elapsed from the specified transmission time.

### Supplementary Note 16

The communication method according to Supplementary Note 15, further including a transmission rate control step of acquiring a state of the network and controlling a transmission bit rate of the downlink packet transmitted in the communication step on the basis of the acquired state of the network.

### Supplementary Note 17

The communication method according to Supplementary Note 16, wherein, in the transmission rate control step, an increase/decrease status of the RTT in the network is acquired as a state of the network.

### Supplementary Note 18

The communication method according to Supplementary Note 16 or 17, wherein, in the transmission timing control step, transmission timing of the downlink packet in the communication step is controlled on the basis of the specified transmission time, the scheduling interval of the network, and the transmission bit rate of the downlink packet in the communication step.

### REFERENCE SIGNS LIST

1, 2 COMMUNICATION SYSTEM
100 TRANSMISSION-SIDE COMMUNICATION APPARATUS
101 COMMUNICATION UNIT
102 ACQUISITION UNIT
103 TRANSMISSION TIMING CONTROL UNIT
200 RECEPTION-SIDE COMMUNICATION APPARATUS
10 SERVER
11 COMMUNICATION UNIT
12 ACQUISITION UNIT
13 TRANSMISSION TIMING CONTROL UNIT
14 TRANSMISSION RATE CONTROL UNIT
20 BASE STATION
30 UE
40 COMPUTER
41 PROCESSOR
42 MEMORY
43 STORAGE
44 INPUT/OUTPUT INTERFACE
441 DISPLAY APPARATUS
442 INPUT APPARATUS
443 SOUND OUTPUT APPARATUS
45 COMMUNICATION INTERFACE

What is claimed is:

1. A communication apparatus comprising:
a transceiver configured to transmit a downlink packet via a network and receive an acknowledge (ACK) packet for the downlink packet via the network,
at least one memory storing instructions, and
at least one processor configured to execute the instructions to;
acquire a round trip time (RTT) for the downlink packet already transmitted by the transceiver, the RTT being time from when the transceiver transmits the downlink packet to when the transceiver receives the ACK packet, and a transmission time of the downlink packet already transmitted by the transceiver; and
control transmission timing of the downlink packet by the transceiver on the basis of the RTT of the downlink packet already transmitted by the transceiver and a transmission time of the downlink packet already transmitted by the transceiver.

2. The communication apparatus according to claim 1, wherein the at least one processor is further configured to execute the instructions to,
specify a transmission time of a downlink packet with a minimum RTT among downlink packets already transmitted by the transceiver, and
control transmission timing of the downlink packet by the transceiver on the basis of the specified transmission time and a scheduling interval of the network.

3. The communication apparatus according to claim 2, wherein the at least one processor is further configured to execute the instructions to control transmission timing of the downlink packet by the transceiver so that the downlink packet is transmitted when time corresponding to the scheduling interval of the network has elapsed from the specified transmission time.

4. The communication apparatus according to claim 3, wherein the at least one processor is further configured to execute the instructions to acquire a state of the network and control a transmission bit rate of the downlink packet by the transceiver on the basis of the acquired state of the network.

5. The communication apparatus according to claim 4, wherein the at least one processor is further configured to execute the instructions to acquire an increase/decrease status of the RTT in the network as a state of the network.

6. The communication apparatus according to claim 4, wherein the at least one processor is further configured to execute the instructions to control transmission timing of the downlink packet by the transceiver on the basis of the specified transmission time, the scheduling interval of the network, and the transmission bit rate of the downlink packet by the transceiver.

7. A communication system comprising:
a transceiver configured to transmit a downlink packet to a reception-side communication apparatus via a network and receive an acknowledge (ACK) packet for the downlink packet from the reception-side communication apparatus via the network;
at least one memory storing instructions, and
at least one processor configured to execute the instructions to;
acquire a round trip time (RTT) for the downlink packet already transmitted by the transceiver, the RTT being time from when the transceiver transmits the downlink packet to when the transceiver receives the ACK packet, and a transmission time of the downlink packet already transmitted by the transceiver; and
control transmission timing of the downlink packet by the transceiver on the basis of the RTT of the downlink packet already transmitted by the transceiver and a transmission time of the downlink packet already transmitted by the transceiver.

8. The communication system according to claim 7, wherein the at least one processor is further configured to execute the instructions to,
specify a transmission time of a downlink packet with a minimum RTT among downlink packets already transmitted by the transceiver, and
control transmission timing of the downlink packet by the transceiver on the basis of the specified transmission time and a scheduling interval of the network.

9. The communication system according to claim 8, wherein the at least one processor is further configured to execute the instructions to control transmission timing of the downlink packet by the transceiver so that the downlink packet is transmitted when time corresponding to the scheduling interval of the network has elapsed from the specified transmission time.

10. The communication system according to claim 9, wherein the at least one processor is further configured to execute the instructions to acquire a state of the network and control a transmission bit rate of the downlink packet by the transceiver on the basis of the acquired state of the network.

11. The communication system according to claim 10, wherein the at least one processor is further configured to execute the instructions to acquire an increase/decrease status of the RTT in the network as a state of the network.

12. The communication system according to claim 10, wherein the at least one processor is further configured to execute the instructions to control transmission timing of the downlink packet by the transceiver on the basis of the specified transmission time, the scheduling interval of the network, and the transmission bit rate of the downlink packet by the transceiver.

13. A communication method by a communication apparatus, the method comprising:
a communication step of transmitting a downlink packet via a network and receiving an acknowledge (ACK) packet for the downlink packet via the network;
an acquisition step of acquiring a round trip time (RTT) for the downlink packet already transmitted in the communication step, the RTT being time from when the downlink packet is transmitted in the communication step to when the ACK packet is received in the transmission step, and a transmission time of the downlink packet already transmitted in the communication step; and
a transmission timing control step of controlling transmission timing of the downlink packet in the communication step on the basis of the RTT of the downlink packet already transmitted in the communication step and a transmission time of the downlink packet already transmitted in the communication step.

14. The communication method according to claim 13, wherein, in the transmission timing control step,
a transmission time of a downlink packet with a minimum RTT among downlink packets already transmitted in the communication step is specified, and
transmission timing of the downlink packet in the communication step is controlled on the basis of the specified transmission time and a scheduling interval of the network.

15. The communication method according to claim 14, wherein, in the transmission timing control step, transmission timing of the downlink packet in the communication step is controlled so that the downlink packet is transmitted when time corresponding to the scheduling interval of the network has elapsed from the specified transmission time.

16. The communication method according to claim 15, further comprising a transmission rate control step of acquiring a state of the network and controlling a transmission bit rate of the downlink packet in the communication step on the basis of the acquired state of the network.

17. The communication method according to claim 16, wherein, in the transmission rate control step, an increase/decrease status of the RTT in the network is acquired as a state of the network.

18. The communication method according to claim 16, wherein, in the transmission timing control step, transmission timing of the downlink packet in the communication step is controlled on the basis of the specified transmission time, the scheduling interval of the network, and the transmission bit rate of the downlink packet in the communication step.
